(19) United States
(12) Patent Application Publication
(10) Pub. No.: US 2010/0190638 A1
(43) Pub. Date: Jul. 29, 2010

(54) Method For Producing A Shell Catalyst and Corresponding Shell Catalyst

(75) Inventors: Alfred Hagemeyer, Bad Aibling (DE); Gerhard Mestl, Munich (DE); Peter Scheck, Gilching (DE); Silvia Neumann, Grosskarolinenfeld (DE)

Correspondence Address: CONNOLLY BOVE LODGE & HUTZ LLP, 1875 EYE STREET, N.W., SUITE 1100, WASHINGTON, DC, 20006, US

(73) Assignee: Sud-Chemie AG, Munich (DE)

(21) Appl. No.: 12/602,026

(22) PCT Filed: May 30, 2008
(86) PCT No.: PCT/EP08/04332

§ 371 Date: Mar. 24, 2010

(30) Foreign Application Priority Data
May 31, 2007 (DE) 10 2007 025 356.9

(51) Int. Cl. B01J 23/66; B01J 23/00; B01J 21/08; B01J 21/04; B01J 21/06; B01J 23/20; B01J 23/40; B01J 23/48; B01J 23/44; B01J 23/50; B01J 23/755; B01J 23/72; B01J 31/20; B01J 23/30; B01J 23/58; B01J 23/745; B01J 8/08

(52) U.S. Cl. 502/161; 502/300; 502/240; 502/355; 502/349; 502/350; 502/353; 502/325; 502/344; 502/339; 502/347; 502/337; 502/345; 502/330; 502/313; 502/328; 502/326; 422/211

(57) ABSTRACT

A method for producing a shell catalyst comprising a porous catalyst support shaped body with an outer shell containing at least one transition metal in metal form. To provide a shell catalyst with a relatively small shell thickness, a device is set up to circulate the catalyst support shaped bodies by means of process gases with a reductive effect. The device is charged with catalyst support shaped bodies that are circulated by means of a process gas with a reductive effect, an outer shell of the catalyst support shaped bodies is impregnated with a transition-metal precursor compound by spraying the circulating catalyst support shaped bodies with a solution containing the transition-metal precursor compound, the metal component of the transition-metal precursor compound is converted into the metal form by reduction by means of the process gas, and the catalyst support shaped bodies sprayed with the solution are dried.

### CROSS REFERENCE TO RELATED APPLICATIONS

This is a National Phase application of PCT application number PCT/EP2008/004332, filed May 30, 2008, which claims priority benefit of German application number DE 10 2007 025 356.9, filed May 31, 2007, the content of such applications being incorporated herein by reference.

### FIELD OF THE INVENTION

The present invention relates to a method for producing a shell catalyst which comprises a porous catalyst support shaped body with an outer shell in which at least one transition metal in metal form is contained.

### BACKGROUND OF THE INVENTION

Supported transition-metal catalysts in the form of shell catalysts and also methods for their production are known in the state of the art. The catalytically active species—often also the promoters—are contained in shell catalysts only in an outer area (shell) of greater or lesser width of a catalyst support shaped body, i.e. they do not fully penetrate the catalyst support shaped body (cf. for example EP 565 952 A1, EP 634 214 A1, EP 634 209 A1 and EP 634 208 A1). With shell catalysts, a more selective reaction control is possible in many cases than with catalysts in which the support is loaded into the core of the support with the catalytically active species (“impregnated through”).

Vinyl acetate monomer (VAM) for example is currently produced predominantly by means of shell catalysts in high selectivity. The great majority of the shell catalysts used at present for producing VAM are shell catalysts with a Pd/Au shell on a porous amorphous aluminosilicate support, formed as a sphere, based on natural sheet silicates, wherein the supports are impregnated through with potassium acetate as promoter. In the Pd/Au system of these catalysts, the active metals Pd and Au are probably not present in the form of metal particles of the respective pure metal, but rather in the form of Pd/Au-alloy particles of possibly different composition, although the presence of unalloyed particles cannot be ruled out.

VAM shell catalysts are usually produced by the so-called chemical route in which the catalyst support is steeped in solutions of corresponding metal compounds, for example by dipping the support into the solutions, or by means of the incipient wetness method (pore-filling method) in which the support is loaded with a volume of solution corresponding to its pore volume.

The Pd/Au shell of a VAM shell catalyst is produced for example by first steeping the catalyst support shaped body in a first step in an Na₂PdCl₄ solution and then in a second step fixing the Pd component with NaOH solution onto the catalyst support in the form of a Pd-hydroxide compound. In a subsequent, separate third step, the catalyst support is then steeped in an NaAuCl₄ solution and then the Au component is likewise fixed by means of NaOH. It is also possible for example to firstly steep the support in lye and then apply the precursor compounds to the thus-pretreated support. After the fixing of the noble-metal components to the catalyst support, the loaded catalyst support is then very largely washed free of chloride and Na ions, then dried and finally reduced with ethylene at 150° C. The produced Pd/Au shell is usually approximately 100 to 500 μm thick, wherein normally the smaller the thickness of its shell, the higher the product selectivity of a shell catalyst.

Usually, the catalyst support loaded with the noble metals is then loaded with potassium acetate after the fixing or reducing step wherein, rather than the loading with potassium acetate taking place only in the outer shell loaded with noble metals, the catalyst support is completely impregnated through with the promoter.

According to the state of the art, the active metals Pd and Au, starting from chloride compounds in the area of a shell of the support, are applied to same by means of steeping. However, this technique has reached its limits as regards minimum shell thicknesses. The smallest achievable shell thickness of correspondingly produced VAM catalysts is at best approx. 100 μm and it is not foreseen that even thinner shells can be obtained by means of steeping. In addition, the catalysts produced by means of steeping have a relatively large average dispersion of the noble-metal particles, which can have a disadvantageous effect in particular on the activity of the catalyst.

### SUMMARY OF THE INVENTION

An object of the present invention is to provide a shell catalyst production method by means of which supported transition-metal catalysts formed as shell catalysts can be produced which have a relatively small shell thickness.

This object is achieved by a first method using a device which is set up to cause a circulation of the catalyst support shaped bodies, by means of a process gas with a reductive effect, comprising the steps of
a) charging the device with catalyst support shaped bodies and causing a circulation of the catalyst support shaped bodies by means of a process gas with a reductive effect;
b) impregnating an outer shell of the catalyst support shaped bodies with a transition-metal precursor compound by spraying the circulating catalyst support shaped bodies with a solution containing the transition-metal precursor compound;
c) converting the metal component of the transition-metal precursor compound into the metal form by reduction by means of the process gas;
d) drying the catalyst support shaped bodies sprayed with the solution.

Surprisingly, it has been established that shell catalysts with relatively thin shells, in particular smaller than 100 μm, can be produced by means of the method according to aspects of the invention.

Furthermore, transition-metal shell catalysts with relatively high metal loading can be produced by means of the method according to aspects of the invention, wherein the metal particles of the catalysts have a relatively high average dispersion.

The first method according to aspects of the invention is carried out with a process gas with a reductive effect. It is thereby made possible that the metal component of the transition-metal precursor compound is reduced to the metal immediately after deposition onto the catalyst support and is thereby fixed to the support. The reduction of metal component to the metal is thus continuous while the method according to aspects of the invention is being carried out, as long as fresh metal compound is being deposited onto the supports.

Within the framework of the method according to aspects of the invention, the shaped bodies sprayed with the solution are preferably dried continuously by means of the process gas. However, it can also be provided that a separate final drying step is carried out after impregnation accompanied by continuous drying. In the first case, for example, the drying speed and thus the penetration depth (thickness of the shell) can be set individually by the temperature of the process gas or of the shaped bodies, in the second case the drying can be carried out using any drying method known to a person skilled in the art to be suitable.

If the shell catalyst to be produced is to contain more than one different transition metal in the shell, for example more than one active metal or an active metal and a promoter metal, then the catalyst support shaped body can for example be subjected correspondingly frequently to the method according to aspects of the invention.

Alternatively, the method according to aspects of the invention can also be carried out with mixed solutions which contain transition-metal precursor compounds of different metals. Furthermore, the method according to aspects of the invention can be carried out by spraying the catalyst supports with several solutions of precursor compounds of different metals at the same time.

The process gas with a reductive effect to be used in the method according to aspects of the invention is preferably a gas mixture, comprising an inert gas and a component with a reductive effect. The reduction speed and thus also, to a certain extent, the shell thickness can be set inter alia via the proportion in the gas mixture of the component with a reductive effect.

Preferably, a gas selected from the group consisting of nitrogen, carbon dioxide and the noble gases, preferably helium and argon, or mixtures of two or more of the above-named gases is used as inert gas.

The component with a reductive effect is normally to be selected according to the nature of the metal component to be reduced, but preferably selected from the group of gases or vaporable liquids consisting of ethylene, hydrogen, CO, NH₃, formaldehyde, methanol, formic acid and hydrocarbons, or is a mixture of two or more of the above-named gases/liquids.

In particular in respect of noble metals as metal components to be reduced, gas mixtures of hydrogen with nitrogen or argon can be preferred, preferably with a hydrogen content between 1 vol.-% and 15 vol.-%. The method according to aspects of the invention is carried out for example with hydrogen (5 vol.-%) in nitrogen as process gas at a temperature of approximately 150° C. over a period of for example 5 hours. If the desired quantity of transition-metal precursor compound solution has been deposited onto the shaped bodies, the spraying can be stopped and the circulation continued until the deposited metal component has been completely reduced.

### DESCRIPTION OF THE DRAWINGS

FIG. 1Aa is a vertical sectional view of a preferred device for carrying out the method according to aspects of the invention;

FIG. 1B is an enlargement of the framed area in FIG. 1A numbered 1B;

FIG. 2Aa is a perspective sectional view of the preferred device, in which the movement paths of two elliptically circulating catalyst support shaped bodies are represented schematically;

FIG. 2B is a plan view of the preferred device and the movement paths according to FIG. 2A;

FIG. 3A is a perspective sectional view of the preferred device, in which the movement path of a toroidally circulating catalyst support shaped body is represented schematically; and

FIG. 3B is a plan view of the preferred device and the movement path according to FIG. 3A.

### DETAILED DESCRIPTION OF THE PREFERRED EMBODIMENTS

The terms “catalyst support shaped body”, “catalyst support”, “shaped body” and “support” are used synonymously within the framework of the present invention.

The above-named object is furthermore achieved by a second method using a device which is set up to cause a circulation of the catalyst support shaped bodies, preferably by means of a process gas, comprising the steps of
a) charging the device with catalyst support shaped bodies and causing a circulation of the catalyst support shaped bodies, preferably by means of a process gas;
b) impregnating an outer shell of the catalyst support shaped bodies with a transition-metal precursor compound by spraying the circulating catalyst support shaped bodies with a solution containing the transition-metal precursor compound;
c) converting the metal component of the transition-metal precursor compound into the metal form by means of a reducing agent which is deposited onto the catalyst support shaped body by impregnating at least the outer shell of the catalyst support shaped body by spraying the circulating catalyst support shaped bodies with a solution containing the reducing agent;
d) drying the catalyst support shaped bodies.

The second method according to aspects of the invention has the same advantages, named above, as the first method according to aspects of the invention.

The statements concerning the first method in respect of drying and the production of shell catalysts in the shells of which several different transition metals are contained apply analogously to the second method according to aspects of the invention.

The catalyst supports can for example be sprayed with the solution of the transition-metal precursor compound and with the solution of the reducing agent one after the other, wherein either solution can be sprayed first. However, it is preferred if the two solutions are sprayed onto the catalyst supports at the same time, preferably with a two-product nozzle formed as an annular gap nozzle.

Reducing agents which are preferably used in the second method according to aspects of the invention are selected from the group consisting of hydrazine, K-formate, Na-formate, ammonium formate, formic acid, K-hypophosphite, hypophosphoric acid, H₂O₂ and Na-hypophosphite.

For the second method according to aspects of the invention, the process gas is preferably selected from the group consisting of air, oxygen, nitrogen and the noble gases, preferably helium and argon.

In the first and the second method according to aspects of the invention, the circulation of the catalyst support shaped bodies is preferably achieved by producing a fluid bed or a fluidized bed of catalyst support shaped bodies by means of the process gas. A particularly uniform deposition of the respective solution onto the catalyst supports is thereby ensured.

In the second method according to aspects of the invention, the catalyst support shaped bodies can also be circulated for example by means of coating drums or mixing devices. Accordingly, the first method according to aspects of the invention can be carried out using fluid bed units or fluidized bed units as the device, while the second method according to aspects of the invention can also be carried out using coating drums, mixers, pelleting devices or double cone mixers as the device.

Suitable coating drums, fluid bed units and fluidized bed units for carrying out the methods according to aspects of the invention according to preferred embodiments are known in the state of the art and sold e.g. by Heinrich Brucks GmbH (Alfeld, Germany), ERWEK GmbH (Heusenstamm, Germany), Stechel (Germany), DRIAM Anlagenbau GmbH (Eriskirch, Germany), Glatt GmbH (Binzen, Germany), G.S. Divisione Verniciatura (Osteria, Italy), HOFER-Pharma Maschinen GmbH (Weil am Rhein, Germany), L. B. Bohle Maschinen+Verfahren GmbH (Enningerloh, Germany), Lodige Maschinenbau GmbH (Paderborn, Germany), Manesty (Merseyside, United Kingdom), Vector Corporation (Marion, Iowa, USA), Aeromatic-Fielder AG (Bubendorf, Switzerland), GEA Process Engineering (Hampshire, United Kingdom), Fluid Air Inc. (Aurora, Illinois, USA), Heinen Systems GmbH (Varel, Germany), Hüttlin GmbH (Steinen, Germany), Umang Pharmatech Pvt. Ltd. (Marharashtra, India) and Innojet Technologies (Lorrach, Germany).

The following method embodiments relate—unless otherwise indicated—to both the first and the second method according to aspects of the invention. Accordingly, there is no explicit reference in the following to whether the first or the second method is involved and the term “method” is used in the singular.

According to a particularly preferred embodiment of the method according to aspects of the invention a fluid bed of catalyst support shaped bodies in which the shaped bodies circulate elliptically or toroidally, preferably toroidally, is produced by means of the process gas. A particularly uniform deposition of the solutions to be deposited is thereby ensured, with the result that shell catalysts with a particularly uniform shell thickness can be obtained according to this embodiment. It can be preferred that the elliptically or toroidally circulating shaped bodies circulate at a speed of 1 to 50 cm/s, preferably at a speed of 3 to 30 cm/s and by preference at a speed of 5 to 20 cm/s.

In the method according to aspects of the invention, a fluid bed in which the shaped bodies circulate elliptically or toroidally is preferably produced. In the state of the art, the transition of the particles of a bed into a state in which the particles can move completely freely (fluidized bed) is called the loosening point (incipient fluidization point) and the corresponding fluidization velocity is called the loosening velocity. According to aspects of the invention it is preferred that in the method according to aspects of the invention the fluidization velocity is up to 4 times the loosening velocity, preferably up to 3 times the loosening velocity and more preferably up to 2 times the loosening velocity.

According to an alternative embodiment of the method according to aspects of the invention, it can be provided that the fluidization velocity is up to 1.4 times the common logarithm of the loosening velocity, preferably up to 1.3 times the common logarithm of the loosening velocity and more preferably up to 1.2 times the common logarithm of the loosening velocity.

Fluid bed devices preferred according to aspects of the invention for carrying out the method according to aspects of the invention are described for example in WO 2006/027009 A1, DE 102 48 116 B3, EP 0 370 167 A1, EP 0 436 787 B1, DE 199 04 147 A1, DE 20 2005 003 791 U1, the contents of which are incorporated in the present invention through reference. Fluid bed devices which are particularly preferred for carrying out the method according to aspects of the invention are sold by Innojet Technologies under the names Innojet® Ventilus or Innojet® AirCoater. These devices comprise a cylindrical container with a fixedly and immovably installed container bottom in the centre of which a spraying nozzle is mounted. The bottom consists of annular plates arranged in steps above each other. In these devices, the process gas flows horizontally into the container between the individual plates eccentrically, with a circumferential flow component, outwardly towards the container wall. So-called air flow beds form on which the catalyst support shaped bodies are first transported outwardly towards the container wall. A perpendicularly oriented process air stream which deflects the catalyst supports upwards is installed outside along the container wall. Having reached the top, the catalyst supports move on a more or less tangential path back towards the centre of the bottom, in the course of which they pass through the spray mist of the nozzle. After passing through the spray mist, the described movement process begins again. The described process-gas guiding provides the basis for a largely homogeneous, toroidal fluid-bed-like circulating movement of the catalyst supports.

Unlike a conventional fluid bed, the effect of the combined action of the spraying with the elliptical or toroidal movement of the catalyst supports in the fluid bed is that the individual catalyst supports pass through the spraying nozzles at an approximately identical frequency. In addition, such a circulation process also sees to it that the individual catalyst supports rotate about their own axis, for which reason the catalyst supports can be impregnated particularly evenly.

According to the preferred embodiment in question of the method according to aspects of the invention, the catalyst support shaped bodies circulate in the fluid bed elliptically or toroidally, preferably toroidally. To give an idea of how the shaped bodies move in the fluid bed, it may be stated that in the case of “elliptical circulation” the catalyst support shaped bodies move in the fluid bed in a vertical plane on an elliptical path, the size of the major and minor axis changing. In the case of “toroidal circulation” the catalyst support shaped bodies move in the fluid bed in the vertical plane on an elliptical path, the size of the major and minor axis changing, and in the horizontal plane on a circular path, the size of the radius changing. On average, the shaped bodies move in the case of “elliptical circulation” in the vertical plane on an elliptical path, in the case of “toroidal circulation” on a toroidal path, i.e. a shaped body covers the surface of a torus helically with a vertically elliptical section.

To produce a catalyst support shaped body fluid bed in which the catalyst support shaped bodies circulate elliptically or toroidally in a manner that is simple, in terms of process engineering, and thus inexpensive, it is provided, according to a further preferred embodiment of the method according to aspects of the invention, that the device comprises a process chamber with a bottom and a side wall, wherein the process gas is fed, with a horizontal movement component aligned radially outwards, into the process chamber through the bottom of the process chamber, the bottom being preferably constructed of several overlapping annular guide plates laid one over another between which annular slots are formed.

Because process gas is fed into the process chamber with a horizontal movement component aligned radially outwards, an elliptical circulation of the catalyst supports in the fluid bed is brought about. If the shaped bodies are to circulate toroidally in the fluid bed, the shaped bodies must also be subjected to a further circumferential movement component which forces the shaped bodies onto a circular path. The shaped bodies can be subjected to this circumferential movement component for example by attaching suitably aligned guide rails to the side wall to deflect the catalyst supports. According to a further preferred embodiment of the method according to aspects of the invention, however, it is provided that the process gas fed into the process chamber is subjected to a circumferential flow component. The production of the catalyst support shaped body fluid bed in which the catalyst support shaped bodies circulate toroidally is thereby ensured in a manner that is simple in terms of process engineering and thus inexpensive.

To subject the process gas fed into the process chamber to the circumferential flow component, it can be provided according to a further preferred embodiment of the method according to aspects of the invention that suitably shaped and aligned process gas guide elements are arranged between the annular guide plates. As an alternative or in addition to this, it can be provided that the process gas fed into the process chamber is subjected to the circumferential flow component by feeding additional process gas, with a movement component aligned diagonally upwards, through the bottom of the process chamber into the process chamber, preferably in the area of the side wall of the process chamber.

It can be provided that the catalyst support shaped bodies are sprayed with the solution by means of an annular gap nozzle which atomizes a spray cloud, wherein the plane of symmetry of the spray cloud preferably runs parallel to the plane of the device bottom. Due to the 360° circumference of the spray cloud, the shaped bodies can be sprayed particularly evenly with the solution. The annular gap nozzle, i.e. its mouth, is preferably completely embedded in the shaped bodies.

According to a further preferred embodiment of the method according to aspects of the invention, it is provided that the annular gap nozzle is centrally arranged in the bottom and the mouth of the annular gap nozzle is completely embedded in the circulating catalyst supports. It is thereby ensured that the distance covered by the drops of the spray cloud until they meet a shaped body is relatively short and, accordingly, relatively little time remains for the drops to coalesce into larger drops, which could work against the formation of a largely uniform shell thickness.

According to a further preferred embodiment of the method according to aspects of the invention, it can be provided that a gas support cushion is produced on the underside of the spray cloud. The bottom cushion keeps the bottom surface largely free of sprayed solution, for which reason almost all of the sprayed solution is introduced into the circulating shaped bodies, with the result that hardly any spray losses occur, which is important on cost grounds, in particular in respect of expensive noble-metal precursor compounds.

According to a further preferred embodiment of the method according to aspects of the invention, it is provided that the catalyst support is formed spherical. A uniform rotation of the support about its axis and concomitantly a uniform impregnation of the catalyst support with the solution of the catalytically active species are thereby ensured.

In the method according to aspects of the invention, porous shaped bodies of any shape can be used as catalyst supports, wherein the supports can be formed from any materials or material mixtures. However, catalyst supports which comprise at least one metal oxide or are formed from a metal oxide or a metal oxide mixture are preferred according to aspects of the invention. However, the catalyst support preferably comprises a silicon oxide, an aluminium oxide, an aluminosilicate, a zirconium oxide, a titanium oxide, a niobium oxide or a natural sheet silicate, preferably a calcined acid-treated bentonite.

By “natural sheet silicate”, for which the term “phyllosilicate” is also used in the literature, is meant untreated or treated silicate mineral from natural sources in which SiO₄ tetrahedra, which form the structural base unit of all silicates, are cross-linked with each other in layers of the general formula [Si₂O₅]²⁻. These tetrahedron layers alternate with so-called octahedron layers in which a cation, principally Al³⁺ and Mg²⁺, is octahedrally surrounded by OH or O. A distinction is drawn for example between two-layer phyllosilicates and three-layer phyllosilicates. Sheet silicates preferred within the framework of the present invention are clay minerals, in particular kaolinite, beidellite, hectorite, saponite, nontronite, mica, vermiculite and smectites, wherein smectites and in particular montmorillonite are particularly preferred. Definitions of the term “sheet silicates” are to be found for example in “Lehrbuch der anorganischen Chemie”, Hollemann Wiberg, de Gruyter, 102^{nd} edition, 2007 (ISBN 978-3-11-017770-1) or in “Römpp Lexikon Chemie”, 10^{th} edition, Georg Thieme Verlag under the heading “Phyllosilikat”. Typical treatments to which a natural sheet silicate is subjected before use as support material include for example a treatment with acids and/or calcining. A natural sheet silicate particularly preferred within the framework of the present invention is a bentonite. Bentonites are not really natural sheet silicates, but rather a mixture of predominantly clay minerals containing sheet silicates. Thus in the present case, where the natural sheet silicate is a bentonite, it is to be understood that the natural sheet silicate is present in the catalyst support in the form of or as a constituent of a bentonite.

A catalyst support formed as a shaped body based on natural sheet silicates, in particular based on an acid-treated calcined bentonite, can be produced for example by moulding, accompanied by compression, a mixture of shapes containing an acid-treated (uncalcined) bentonite as sheet silicate and water into a shaped body by means of devices familiar to a person skilled in the art, such as for example extruders or tablet presses, and then calcining the uncured shaped body to form a stable shaped body. The size of the specific surface area of the catalyst support depends in particular on the quality of the (untreated) bentonite used, the acid-treatment method of the bentonite used, i.e. for example the nature and the quantity, relative to the bentonite, and the concentration of the inorganic acid used, the acid-treatment duration and temperature, on the moulding pressure and on the calcining duration and temperature and the calcining atmosphere.

Acid-treated bentonites can be obtained by treating bentonites with strong acids such as for example sulphuric acid, phosphoric acid or hydrochloric acid. A definition, also valid within the framework of the present invention, of the term bentonite is given in Römpp, Lexikon Chemie, 10^{th} edition, Georg Thieme Verlag. Bentonites particularly preferred within the framework of the present invention are natural aluminium-containing sheet silicates which contain montmorillonite (as smectite) as main mineral. After the acid treatment, the bentonite is as a rule washed with water, dried and ground to a powder.

It was found that relatively large shell thicknesses can also be achieved by means of the method according to aspects of the invention. In fact, the smaller the surface area of the support, the greater the achievable thickness of the shell. According to a further preferred embodiment of the method according to aspects of the invention, it can be provided that the catalyst support has a surface area of less than/equal to 160 m²/g, preferably less than 140 m²/g, by preference less than 135 m²/g, further preferably less than 120 m²/g, more preferably less than 100 m²/g, still more preferably less than 80 m²/g and particularly preferably less than 65 m²/g. By “surface area” of the catalyst support is meant within the framework of the present invention the BET surface area of the support which is determined by means of adsorption of nitrogen according to DIN 66132.

According to a further preferred embodiment of the method according to aspects of the invention, it is provided that the catalyst support has a surface area of 160 to 40 m²/g, preferably between 140 and 50 m²/g, by preference between 135 and 50 m²/g, further preferably between 120 and 50 m²/g, more preferably between 100 and 50 m²/g and most preferably between 100 and 60 m²/g.

Within the framework of the method according to aspects of the invention, the catalyst supports are subjected to a mechanical load stress during the circulation of the supports, which can result in a degree of wear and a degree of damage to catalyst supports, in particular in the area of the resulting shell. In particular to keep the wear of the catalyst support within reasonable limits, the catalyst support has a hardness greater than/equal to 20 N, preferably greater than/equal to 30 N, further preferably greater than/equal to 40 N and most preferably greater than/equal to 50 N. The hardness is ascertained by means of an 8M tablet-hardness testing machine from Dr. Schleuniger Pharmatron AG, determining the average for 99 shaped bodies after drying at 130° C. for 2 h, wherein the apparatus settings are as follows:

| | |
|---|---|
| Hardness: | N |
| Distance from the shaped body: | 5.00 mm |
| Time delay: | 0.80 s |
| Feed type: | 6 D |
| Speed: | 0.60 mm/s |

The hardness of the catalyst support can be influenced for example by varying certain parameters of the method for its production, for example through the selection of the support material, the calcining duration and/or the calcining temperature of an uncured shaped body formed from a corresponding support mixture, or by particular loading materials, such as for example methyl cellulose or magnesium stearate.

On the grounds of cost, air is preferably used as process gas in the method according to aspects of the invention. However, if for example the catalytically active species or the precursor thereof should react with atmospheric oxygen to form undesired compounds, it can also be provided that an inert gas is used as process gas, for example nitrogen, methane, CO₂, short-chain saturated hydrocarbons, one of the noble gases, preferably helium, neon or argon, or a halogenated hydrocarbon.

According to a further preferred embodiment of the method according to aspects of the invention, the process gas can be recycled into the device by means of a closed loop, above all in the case of expensive gases such as e.g. helium, argon, etc.

According to a further preferred embodiment of the method according to aspects of the invention, the catalyst support is heated prior to and/or during the deposition of the solution, for example by means of a heated process gas. The drying-off speed of the deposited solution of the transition-metal precursor compound can be determined via the degree of heating of the catalyst supports. At relatively low temperatures the drying-off speed is for example relatively low, with the result that with a corresponding quantitative deposition, greater shell thicknesses can be formed because of the high diffusion of the metal compound that is caused by the presence of solvent. At relatively high temperatures the drying-off speed is for example relatively high, with the result that solution coming into contact with the catalyst support almost immediately dries off, which is why solution deposited on the catalyst support cannot penetrate deep into the latter. At relatively high temperatures shells with relatively small thicknesses and a high metal loading can thus be obtained. Accordingly, according to a further preferred embodiment of the method according to aspects of the invention, the process gas is heated, preferably to a temperature of more than/equal to 40° C., by preference to a temperature of more than/equal to 60° C., further preferably to a temperature of more than/equal to 70° C. and most preferably to a temperature of 60 to 110° C.

The thickness of the shell of the shell catalyst resulting from the method according to aspects of the invention can be influenced by the temperature at which the method according to aspects of the invention is carried out. In fact, thinner shells are normally obtained when the method is carried out at higher temperatures, whereas thicker shells are normally obtained at lower temperatures. According to a further preferred embodiment, it is therefore provided that the process gas is heated, preferably to a temperature between 80 and 200° C.

To prevent drops of the spray cloud from drying prematurely, it can be provided according to a further preferred embodiment of the method according to aspects of the invention that the process gas is enriched, before being fed into the device, with the solvent of the solution sprayed into the device, preferably in a range of 10 to 50% of the saturation vapour pressure (at process temperature).

According to a further preferred embodiment of the method according to aspects of the invention, the solvent added to the process gas and also solvents originating from the drying of the shaped bodies can be separated from the process gas by means of suitable cooling aggregates, condensers and separators and returned to the solvent enricher by means of a pump.

Solutions of metal compounds of any transition metals can be used in the method according to aspects of the invention. However, it is preferred that the solution of the transition-metal precursor compound contains a noble-metal compound as transition-metal precursor compound.

According to a further preferred embodiment of the method according to aspects of the invention, it is provided that the noble-metal compound is selected from the halides, in particular chlorides, oxides, nitrates, nitrites, formates, propionates, oxalates, acetates, citrates, tartrates, lactates, hydroxides, hydrogen carbonates, amine complexes or organic complexes, for example triphenylphosphine complexes or acetylacetonate complexes, of the noble metals.

To produce a shell catalyst for oxidation reactions, it is provided according to a further preferred embodiment of the method according to aspects of the invention that the solution of the transition-metal precursor compound contains a Pd compound as transition-metal precursor compound.

To produce a gold-containing shell catalyst, it is provided according to a further preferred embodiment of the method according to aspects of the invention that the solution of the transition-metal precursor compound contains an Au compound as transition-metal precursor compound.

To produce a platinum-containing shell catalyst, it is provided according to a further preferred embodiment of the method according to aspects of the invention that the solution of the transition-metal precursor compound contains a Pt compound as transition-metal precursor compound.

To produce a silver-containing shell catalyst, it is provided according to a further preferred embodiment of the method according to aspects of the invention that the solution of the transition-metal precursor compound contains an Ag compound as transition-metal precursor compound.

Accordingly, it can be provided according to a further preferred embodiment of the method according to aspects of the invention for producing a nickel, cobalt or copper-containing shell catalyst that the solution of the transition-metal precursor compound contains an Ni, Co or Cu compound as transition-metal precursor compound.

With the methods described in the state of the art for producing VAM shell catalysts based on Pd and Au, commercially available solutions of the precursor compounds such as Na₂PdCl₄, NaAuCl₄ or HAuCl₄ solutions are customarily used. In the more recent literature, chloride-free Pd or Au precursor compounds such as for example Pd(NH₃)₄(OH)₂, Pd(NH₃)₂(NO₂)₂ and KAuO₂ are also used. These precursor compounds react base in solution, while the standard chloride, nitrate and acetate precursor compounds all react acid in solution.

In principle, any Pd or Au compound by means of which a degree of dispersion of the metal particles high enough for VAM synthesis can be achieved can be used as Pd and Au precursor compound. By “degree of dispersion” is meant the ratio of the number of all the surface metal atoms (of the metal concerned) of all the metal/alloy particles of a supported metal catalyst to the total number of all the metal atoms of the metal/alloy particles. In general it is preferred if the degree of dispersion corresponds to a relatively high numerical value, since in this case as many metal atoms as possible are freely accessible for a catalytic reaction. This means that, given a relatively high degree of dispersion of a supported metal catalyst, a specific catalytic activity of same can be achieved with a relatively small quantity of metal used.

Examples of preferred Pd precursor compounds are water-soluble Pd salts. According to a particularly preferred embodiment of the method according to aspects of the invention, the Pd precursor compound is selected from the group consisting of H₂PdCl₄, K₂PdCl₄, (NH₄)₂PdCl₄, Pd(NH₃)₄Cl₂, Pd(NH₃)₄(HCO₃)₂, Pd(NH₃)₄(HPO₄), ammonium Pd oxalate, Pd oxalate, K₂Pd(oxalate)₂, Pd(II) trifluoroacetate, Pd(NH₃)₄(OH)₂, Pd(NO₃)₂, K₂Pd(OAc)₂(OH)₂, Pd(NH₃)₂(NO₂)₂, Pd(NH₃)₄(NO₃)₂, K₂Pd(NO₂)₄, Na₂Pd(NO₂)₄, Pd(OAc)₂, PdCl₂ and Na₂PdCl₄. In addition to Pd(OAc)₂ other carboxylates of palladium can also be used, preferably the salts of the aliphatic monocarboxylic acids with 3 to 5 carbon atoms, for example the propionate or the butyrate salt.

According to a further preferred embodiment of the method according to aspects of the invention, Pd nitrite precursor compounds can also be preferred. Preferred Pd nitrite precursor compounds are for example those which are obtained by dissolving Pd(OAc)₂ in an NaNO₂ or KNO₂ solution.

Examples of preferred Au precursor compounds are water-soluble Au salts. According to a particularly preferred embodiment of the method according to aspects of the invention, the Au precursor compound is selected from the group consisting of KAuO₂, NaAuO₂, KAuCl₄, (NH₄)AuCl₄, NaAu(OAc)₃ (OH) , HAuCl₄, KAu(NO₂)₄, AuCl₃, NaAUCl₄, KAu(OAc)₃(OH), HAu(NO₃)₄ and Au(OAc)₃. It is recommended where appropriate to produce fresh Au(OAc)₃ or KAuO₂ each time by precipitating the oxide/hydroxide from a gold acid solution, washing and isolating the precipitate and taking up same in acetic acid or KOH.

Examples of preferred Pt precursor compounds are water-soluble Pt salts. According to a particularly preferred embodiment of the method according to aspects of the invention, the Pt precursor compound is selected from the group consisting of Pt(NH₃)₄(OH)₂, Pt(NO₃)₂, K₂Pt(OAc)₂(OH)₂, Pt(NH₃)₂(NO₂)₂, PtCl₄, H₂Pt(OH)₆, Na₂Pt(OH)₆, K₂Pt(OH)₆, K₂Pt(NO₂)₄, Na₂Pt (NO₂)₄, Pt(OAc)₂, PtCl₂, K₂PtCl₄, H₂PtCl₆, (NH₄)₂PtCl₄, (NH₃)₄PtCl₂, Pt(NH₃)₄ (HCO₃)₂, Pt(NH₃)₄(HPO₄), Pt(NH₃)₄(NO₃)₂ and Na₂PtCl₄. In addition to Pt(OAc)₂ other carboxylates of platinum can also be used, preferably the salts of the aliphatic monocarboxylic acids with 3 to 5 carbon atoms, for example the propionate or butyrate salt. Instead of NH₃ it is also possible to use the corresponding complex salts with ethylenediamine or ethanolamine as ligand.

According to a further preferred embodiment of the method according to aspects of the invention, Pt nitrite precursor compounds may also be preferred. Preferred Pt nitrite precursor compounds are for example those which are obtained by dissolving Pt(OAc)₂ in an NaNO₂ solution.

Examples of preferred Ag precursor compounds are water-soluble Ag salts. According to a particularly preferred embodiment of the method according to aspects of the invention, the Ag precursor compound is selected from the group consisting of Ag(NH₃)₂(OH)₂, Ag(NO₃), K₂Ag(OAc)(OH)₂, Ag(NH₃)₂(NO₂), Ag(NO₂), Ag lactate, Ag trifluoroacetate, Ag salicylate, K₂Ag(NO₂)₃, Na₂Ag(NO₂)₃, Ag(OAc), ammoniacal AgCl₂ solution, ammoniacal Ag₂CO₃ solution, ammoniacal Ago solution and Na₂AgCl₃. In addition to Ag(OAc) other carboxylates of silver can also be used, preferably the salts of the aliphatic monocarboxylic acids with 3 to 5 carbon atoms, for example the propionate or butyrate salt.

According to a further preferred embodiment of the method according to aspects of the invention, Ag nitrite precursor compounds may also be preferred. Preferred Ag nitrite precursor compounds are for example those which are obtained by dissolving Ag(OAc) in an NaNO₂ solution.

Pure solvents and solvent mixtures in which the selected metal compound is soluble and which, after application to the catalyst support, can be easily removed again from same by means of drying are suitable as solvents for the transition-metal precursor compound. Preferred solvent examples for the metal acetates as precursor compounds are above all unsubstituted carboxylic acids, in particular acetic acid, ketones such as acetone, and for the metal chlorides above all water or dilute hydrochloric acid.

If the precursor compound is not sufficiently soluble in acetic acid, water or dilute hydrochloric acid or mixtures thereof, other solvents can also be used as an alternative or in addition to the named solvents. Solvents which are inert preferably come into consideration as other solvents in this case. Ketones, for example acetone or acetylacetone, furthermore ethers, for example tetrahydrofuran or dioxan, acetonitrile, dimethylformamide and solvents based on hydrocarbons such as for example benzene may be named as preferred solvents which are suitable for adding to acetic acid.

Ketones, for example acetone, or alcohols, for example ethanol or isopropanol or methoxyethanol, lyes, such as aqueous KOH or NaOH, or organic acids, such as acetic acid, formic acid, citric acid, tartaric acid, malic acid, glyoxylic acid, glycolic acid, oxalic acid, pyruvic acid or lactic acid may be named as preferred solvents or additives which are suitable for adding to water.

It is preferred if, within the framework of the method according to aspects of the invention, the solvent used in the method is recovered, preferably by means of suitable cooling aggregates, condensers and separators.

The present invention furthermore relates to a shell catalyst comprising a porous catalyst support shaped body with an outer shell in which at least one transition metal is contained in particulate metal form, characterized in that the proportion by mass of the transition metal in the catalyst is more than 0.3 mass-%, preferably more than 0.5 mass-% and by preference more than 0.8 mass-%, and the average dispersion of the transition-metal particles is greater than 20%, preferably greater than 23%, by preference greater than 25% and more preferably greater than 27%.

Transition-metal shell catalysts with such high metal loadings with a simultaneously high metal dispersion can be obtained by means of the method according to aspects of the invention. The transition-metal dispersion is determined by means of the DIN standard for the respective metal in question. On the other hand, the dispersion of the noble metals Pt, Pd and Rh is determined by means of CO chemisorption according to “Journal of Catalysis 120, 370 -376 (1989)”. The dispersion of Cu is determined by means of N₂O.

According to a preferred embodiment of the shell catalyst according to aspects of the invention, the concentration of the transition metal varies, over an area of 90% of the shell thickness, the area being at a distance of 5% of the shell thickness from each of the outer and inner shell limit, from the average concentration of transition metal of this area by a maximum of +/−20%, preferably by a maximum of +/−15% and by preference by a maximum of +/−10%. Due to the largely uniform distribution of the transition metal within the shell, a largely uniform activity of the catalyst according to aspects of the invention over the thickness of the shell is ensured, as the concentration of transition metal varies only relatively little over the shell thickness. In other words, the profile of the concentration of transition metal describes an approximately rectangular function over the shell thickness.

To further increase the selectivity of the catalyst according to aspects of the invention, it can be provided that, seen over the thickness of the shell of the catalyst, the maximum concentration of transition metal is in the area of the outer shell limit and the concentration decreases towards the inner shell limit. It can be preferred if the concentration of transition metal decreases constantly towards the inner shell limit over an area of at least 25% of the shell thickness, preferably over an area of at least 40% of the shell thickness and by preference over an area of 30 to 80% of the shell thickness.

According to a further preferred embodiment of the catalyst according to aspects of the invention, the concentration of transition metal decreases roughly constantly towards the inner shell limit to a concentration of 50 to 90% of the maximum concentration, preferably to a concentration of 70 to 90% of the maximum concentration.

It is preferred if the transition metal is selected from the group of the noble metals.

Catalysts preferred according to aspects of the invention contain two different metals in metal form in the shell, wherein the two metals are combinations of one of the following pairs: Pd and Ag; Pd and Au; Pd and Pt. Catalysts with a Pd/Au shell are suitable in particular for producing VAM, those with a Pd/Pt shell are suitable in particular as oxidation and hydrogenation catalysts and those with a Pd/Ag shell are suitable in particular for the selective hydrogenation of alkynes and dienes in olefin streams, thus for example for producing purified ethylene by selective hydrogenation of acetylene contained in the untreated product.

With regard to the provision of a VAM shell catalyst with adequate VAM activity, it is preferred that the catalyst contains Pd and Au as noble metals and the proportion of Pd in the catalyst is 0.6 to 2.5 mass-%, preferably 0.7 to 2.3 mass-% and by preference 0.8 to 2 mass-%, relative to the mass of the catalyst support loaded with noble metal.

In addition, it is preferred in the above connection that the Au/Pd atomic ratio of the catalyst is between 0 and 1.2, preferably between 0.1 and 1, by preference between 0.3 and 0.9 and particularly preferably between 0.4 and 0.8.

In the case of a Pd/Au shell catalyst, this preferably contains, as promoter, at least one alkali metal compound, preferably a potassium, sodium, caesium or rubidium compound, by preference a potassium compound. Suitable and particularly preferred potassium compounds include potassium acetate KOAc, potassium carbonate K₂CO₃, potassium hydrogen carbonate KHCO₃ and potassium hydroxide KOH and also all potassium compounds which become K-acetate KOAc under the respective reaction conditions of VAM synthesis. The potassium compound can be deposited onto the catalyst support both before and after the reduction of the metal components into the metals Pd and Au. According to a further preferred embodiment of the catalyst according to aspects of the invention, the catalyst comprises an alkali metal acetate, preferably potassium acetate. It is particularly preferred in order to ensure an adequate promoter activity if the alkali metal acetate content of the catalyst is 0.1 to 0.7 mol/l, preferably 0.3 to 0.5 mol/l.

According to a further preferred embodiment of the Pd/Au catalyst according to aspects of the invention, the alkali metal/Pd atomic ratio is between 1 and 12, preferably between 2 and 10 and particularly preferably between 4 and 9. Preferably, the smaller the surface area of the catalyst support, the lower the alkali metal/Pd atomic ratio.

It has been established that, the smaller the surface area of the catalyst support, the higher the product selectivities of the Pd/Au catalyst according to aspects of the invention. In addition, the smaller the surface area of the catalyst support is, the greater the chosen thickness of the metal shell can be, without appreciable losses of product selectivity having to be accepted. According to a preferred embodiment of the catalyst according to aspects of the invention, the surface of the catalyst support therefore has a surface area of less than/equal to 160 m²/g, preferably less than 140 m²/g, by preference less than 135 m²/g, further preferably less than 120 m²/g, more preferably less than 100 m²/g, still more preferably less than 80 m²/g and particularly preferably less than 65 m²/g.

According to a further preferred embodiment of the Pd/Au catalyst according to aspects of the invention, it can be provided that the catalyst support has a surface area of 160 to 40 m²/g, preferably between 140 and 50 m²/g, by preference between 135 and 50 m²/g, further preferably between 120 and 50 m²/g, more preferably between 100 and 50 m²/g and most preferably between 100 and 60 m²/g.

In view of a small pore diffusion limitation, it can be provided according to a further preferred embodiment of the Pd/Au catalyst according to aspects of the invention that the catalyst support has an average pore diameter of 8 to 50 nm, preferably 10 to 35 nm and by preference 11 to 30 nm.

The acidity of the catalyst support can advantageously influence the activity of the catalyst according to aspects of the invention. According to a further preferred embodiment of the catalyst according to aspects of the invention the catalyst support has an acidity of between 1 and 150 μval/g, preferably between 5 and 130 μval/g and particularly preferably between 10 and 100 μval/g. The acidity of the catalyst support is determined as follows: 100 ml water (with a pH blank value) is added to 1 g of the finely ground catalyst support and extraction carried out for 15 minutes accompanied by stirring. Titration to at least pH 7.0 with 0.01 n NaOH solution follows, wherein the titration is carried out stepwise; 1 ml of the NaOH solution is firstly added dropwise to the extract (1 drop/second), followed by a 2-minute wait, the pH is read, a further 1 ml NaOH added dropwise, etc. The blank value of the water used is determined and the acidity calculation corrected accordingly.

The titration curve (ml 0.01 NaOH against pH) is then plotted and the intersection point of the titration curve at pH 7 determined. The mole equivalents which result from the NaOH consumption for the intersection point at pH 7 are calculated in 10⁻⁶ equiv/g support.

$$Total acid \text{:} \frac{10 * ml 0.01 n NaOH}{1 Support} = μval / g$$

The Pd/Au catalyst is preferably formed as a sphere. Accordingly, the catalyst support is formed as a sphere, preferably with a diameter of more than 1.5 mm, preferably a diameter of more than 3 mm and preferably with a diameter of 4 mm to 9 mm.

To increase the activity of the Pd/Au catalyst according to aspects of the invention, it can be provided that the catalyst support is doped with at least one oxide of a metal selected from the group consisting of Zr, Hf, Ti, Nb, Ta, W, Mg, Re, Y and Fe, preferably with ZrO₂, HfO₂ or Fe₂O₃. It can be preferred if the proportion of dopant oxide in the catalyst support is between 0 and 20 mass-%, preferably 1.0 to 10 mass-% and by preference 3 to 8 mass-%, relative to the mass of the catalyst support.

According to an alternative embodiment of the catalyst according to aspects of the invention, it contains Pd and Ag as noble metals and, to ensure an adequate activity of the catalyst, preferably in the hydrogenation of acetylene, the proportion of Pd in the catalyst is 0.01 to 1.0 mass-%, preferably 0.02 to 0.8 mass-% and by preference 0.03 to 0.7 mass-%, relative to the mass of the catalyst support loaded with noble metal.

Likewise to achieve an adequate activity of the catalyst in the hydrogenation of acetylene, the Ag/Pd atomic ratio of the catalyst is between 0 and 10, preferably between 1 and 5, wherein it is preferred that the thickness of the noble-metal shell is smaller than 60 μm.

According to a further preferred embodiment of the Pd/Ag catalyst according to aspects of the invention, the catalyst support is formed as a sphere with a diameter greater than 1.5 mm, preferably with a diameter greater than 3 mm and by preference with a diameter of 2 to 4 mm, or as cylindrical tablet with dimensions of up to 7×7 mm.

According to a further preferred embodiment of the Pd/Ag catalyst according to aspects of the invention, the catalyst support has a surface area of 1 to 50 m²/g, preferably between 3 and 20 m²/g. Furthermore it can be preferred that the catalyst support has a surface area less than/equal to 10 m²/g, preferably less than/equal to 5 m²/g and by preference less than 2 m²/g.

In order to ensure an adequate activity, a preferred oxidation or hydrogenation catalyst according to aspects of the invention contains Pd and Pt as noble metals, wherein the proportion of Pd in the catalyst is 0.5 to 5 mass-%, preferably 0.1 to 2.5 mass-% and by preference 0.15 to 0.8 mass-%, relative to the mass of the catalyst support loaded with noble metal.

According to a preferred embodiment of the Pd/Pt catalyst according to aspects of the invention, the Pd/Pt atomic ratio of the catalyst is between 10 and 1, preferably between 8 and 5 and by preference between 7 and 4.

According to a further preferred embodiment of the Pd/Pt catalyst according to aspects of the invention, the catalyst support is formed as a cylinder, preferably with a diameter of 0.75 mm to 3 mm and with a length from 0.3 to 7 mm.

It can furthermore be preferred that the catalyst support has a surface area of 50 to 400 m²/g, preferably between 100 and 300 m²/g.

It can also be preferred that the catalyst contains metallic Co, Ni and/or Cu as transition metal in the shell.

According to a further preferred embodiment of the catalyst according to aspects of the invention, it is provided that the catalyst support is a support based on a silicon oxide, an aluminium oxide, an aluminosilicate, a zirconium oxide, a titanium oxide, a niobium oxide or a natural sheet silicate, preferably a calcined acid-treated bentonite. The expression “based on” means that the catalyst support comprises one or more of the named materials.

As already stated above, the catalyst support of the catalyst according to aspects of the invention is subjected to a degree of mechanical stress during production of the catalyst. In addition, the catalyst according to aspects of the invention can be subjected to a strong mechanical load stress during the filling of a reactor, which can result in an undesired formation of dust and damage to the catalyst support, in particular to its catalytically active shell lying in an outer area. In particular to keep the wear of the catalyst according to aspects of the invention within reasonable limits, the catalyst support has a hardness greater than/equal to 20 N, preferably greater than/equal to 30 N, further preferably greater than/equal to 40 N and most preferably greater than/equal to 50 N. The indentation hardness is determined as described above.

The catalyst according to aspects of the invention can preferably comprise as catalyst support a catalyst support based on a natural sheet silicate, in particular an acid-treated calcined bentonite. The expression “based on” means that the catalyst support comprises the corresponding metal oxide. It is preferred according to aspects of the invention if the proportion of natural sheet silicate, in particular acid-treated calcined bentonite, in the catalyst support is greater than/equal to 50 mass-%, preferably greater than/equal to 60 mass-%, by preference greater than/equal to 70 mass-%, further preferably greater than/equal to 80 mass-%, more preferably greater than/equal to 90 mass-% and most preferably greater than/equal to 95 mass-%, relative to the mass of the catalyst support.

It was found that the product selectivity in particular of the Pd/Au catalyst according to aspects of the invention is higher the larger the integral pore volume of the catalyst support. According to a further preferred embodiment of the catalyst according to aspects of the invention, the catalyst support therefore has an integral pore volume according to BJH of more than 0.30 ml/g, preferably more than 0.35 ml/g, and by preference more than 0.40 ml/g.

It can furthermore be preferred in particular in respect of the Pd/Au catalyst that the catalyst support has an integral BJH pore volume of between 0.25 and 0.7 ml/g, preferably between 0.3 and 0.6 ml/g and by preference 0.35 to 0.5 ml/g.

The integral pore volume of the catalyst support is determined according to the BJH method by means of nitrogen adsorption. The surface area of the catalyst support and its integral pore volume are determined according to the BET or according to the BJH method. The BET surface area is determined according to the BET method according to DIN 66131; a publication of the BET method is also found in J. Am. Chem. Soc. 60, 309 (1938). In order to determine the surface area and the integral pore volume of the catalyst support or the catalyst, the sample can be measured for example with a fully automatic nitrogen porosimeter from Micromeritics, type ASAP 2010, by means of which an adsorption and desorption isotherm is recorded.

To determine the surface area and the porosity of the catalyst support or catalyst according to the BET theory, the data are evaluated according to DIN 66131. The pore volume is determined from the measurement data using the BJH method (E. P. Barret, L. G. Joiner, P. P. Halenda, J. Am. Chem. Soc. (73/1951, 373)). Effects of capillary condensation are also taken into account when using this method. Pore volumes of specific pore size ranges are determined by totalling incremental pore volumes which are obtained from the evaluation of the adsorption isotherms according to BJH. The integral pore volume according to the BJH method relates to pores with a diameter of 1.7 to 300 nm.

It can be provided according to a further preferred embodiment of the catalyst according to aspects of the invention that the water absorbency of the catalyst support is 40 to 75%, preferably 50 to 70% calculated as the weight increase due to water absorption. The absorbency is determined by steeping 10 g of the support sample in deionized water for 30 min until gas bubbles no longer escape from the support sample. The excess water is then decanted and the steeped sample blotted with a cotton towel to remove adhering moisture from the sample. The water-laden support is then weighed out and the absorbency calculated as follows:

(amount weighed out (g)−amount weighed in (g))×10=water absorbency (%)

It can be preferred according to a further preferred embodiment, in particular of the Pd/Au catalyst, if at least 80%, preferably at least 85% and by preference at least 90%, of the integral pore volume of the catalyst support is formed from mesopores and macropores. This counteracts a reduced activity, effected by diffusion limitation, of the catalyst according to aspects of the invention, in particular with relatively thick shells. By micropores, mesopores and macropores are meant in this case pores which have a diameter of less than 2 nm, a diameter of 2 to 50 nm and a diameter of more than 50 nm respectively.

The catalyst support of the catalyst according to aspects of the invention is formed as a shaped body. The catalyst support can in principle assume the form of any geometric body to which a corresponding shell can be applied. However, it is preferred if the catalyst support is formed as a sphere, cylinder (also with rounded end surfaces), perforated cylinder (also with rounded end surfaces), trilobe, “capped tablet”, tetralobe, ring, doughnut, star, cartwheel, “reverse” cartwheel, or as a strand, preferably as a ribbed strand or star strand.

The diameter or the length and thickness of the catalyst support of the catalyst according to aspects of the invention is preferably 2 to 9 mm, depending on the geometry of the reactor tube in which the catalyst is to be used.

In general, the smaller the thickness of the shell of the catalyst, the higher the product selectivity of the catalyst according to aspects of the invention. According to a further preferred embodiment of the catalyst according to aspects of the invention, the shell of the catalyst therefore has a thickness of less than 300 μm, preferably less than 200 μm, by preference less than 150 μm, further preferably less than 100 μm and more preferably less than 80 μm. As a rule in the case of supported metal catalysts, the thickness of the shell can be measured visually by means of a microscope. The area in which the metals are deposited appears black, while the areas free of metals appear white. As a rule, the boundary between areas containing metals and areas free of them is very sharp and can clearly be recognized visually. If the above-named boundary is not sharply defined and accordingly not clearly recognizable visually or the shell thickness cannot be determined visually for other reasons, the thickness of the shell corresponds to the thickness of a shell, measured starting from the outer surface of the catalyst support, which contains 95% of the transition metal deposited on the support.

However, it was likewise found that in the case of the catalyst according to aspects of the invention the shell can be formed with a relatively large thickness effecting a high activity of the catalyst, without effecting an appreciable reduction of the product selectivity of the catalyst according to aspects of the invention. Catalyst supports with a relatively small surface area are to be used for this. According to another preferred embodiment of the catalyst according to aspects of the invention, the shell of the catalyst therefore has a thickness of between 200 and 2000 μm, preferably between 250 and 1800 μm, by preference between 300 and 1500 μm and further preferably between 400 and 1200 μm.

The present invention furthermore relates to the use of a device which is set up to cause a circulation of the catalyst support shaped bodies by means of a process gas, preferably a fluid bed or a fluidized bed, preferably a fluid bed, in which the catalyst support shaped bodies circulate elliptically or toroidally, preferably toroidally, for carrying out the method according to aspects of the invention or in the production of a shell catalyst, in particular a shell catalyst according to aspects of the invention. It has been established that shell catalysts which display the above-named advantageous properties can be produced by means of such devices.

According to a preferred embodiment of the use according to aspects of the invention, it is provided that the device comprises a process chamber with a bottom and a side wall, wherein the bottom is constructed of several overlapping annular guide plates laid one over another between which annular slots are formed via which process gas can be fed in with a horizontal movement component aligned radially outwards. The formation of a fluid bed is thereby made possible in a way that is simple in terms of process engineering in which the shaped bodies circulate elliptically or toroidally in a particularly uniform manner, which is accompanied by an increase in product quality.

In order to guarantee a particularly uniform spraying of the shaped bodies, for example with noble metal solutions, it can be provided according to a further embodiment that an annular gap nozzle is centrally arranged in the bottom, the mouth of which is formed such that a spray cloud, the mirror plane of which runs parallel to the bottom plane, can be sprayed with the nozzle.

It can furthermore be preferred that outlets for support gas are provided between the mouth of the annular gap nozzle and the bottom lying beneath it, in order to produce a support cushion on the underside of the spray cloud. The bottom air cushion keeps the bottom surface free of sprayed solution, which means that all of the sprayed solution is introduced into the fluid bed of the shaped bodies, with the result that no spray losses occur, which is important in particular in respect of expensive noble-metal compounds.

According to a further preferred embodiment of the use according to aspects of the invention, the support gas in the device is provided by the annular gap nozzle itself and/or by process gas. These measures allow the support gas to be produced in a wide variety of ways. At the annular gap nozzle itself outlets can be provided via which some of the spray gas emerges in order to contribute to the formation of the support gas. In addition or alternatively, some of the process gas which flows through the bottom can be guided towards the underside of the spray cloud and thereby contribute to the formation of the support gas.

According to a further embodiment of the invention, the annular gap nozzle has a conical head and the mouth runs along a circular conical section surface. It is thereby ensured that the shaped bodies moving vertically downwards through the cone are led uniformly and in a targeted manner to the spray cloud which is sprayed by the circular spray gap in the lower end of the cone.

According to a further embodiment of the use, there is provided in the area between mouth and bottom lying beneath it a truncated-cone-shaped wall which preferably has passage openings for support gas. This measure has the advantage that the previously mentioned harmonic deflection movement at the cone is maintained by the continuation over the truncated cone and in this area support gas can emerge through the passage openings and provide the corresponding support on the underside of the spray cloud.

In a further version of the use, an annular slot for the passage of process gas is formed between the underside of the truncated-cone-shaped wall. This measure has the advantage that the transfer of the shaped bodies onto the air cushion of the bottom can be particularly well controlled and can be carried out in a targeted manner beginning in the area immediately underneath the nozzle.

In order to be able to introduce the spray cloud into the fluid bed at the desired height, it is preferred that the position of the mouth of the nozzle is height-adjustable.

According to a further version of the use according to aspects of the invention, guide elements which impose an extensive flow component on the process gas passing through are arranged between the annular guide plates.

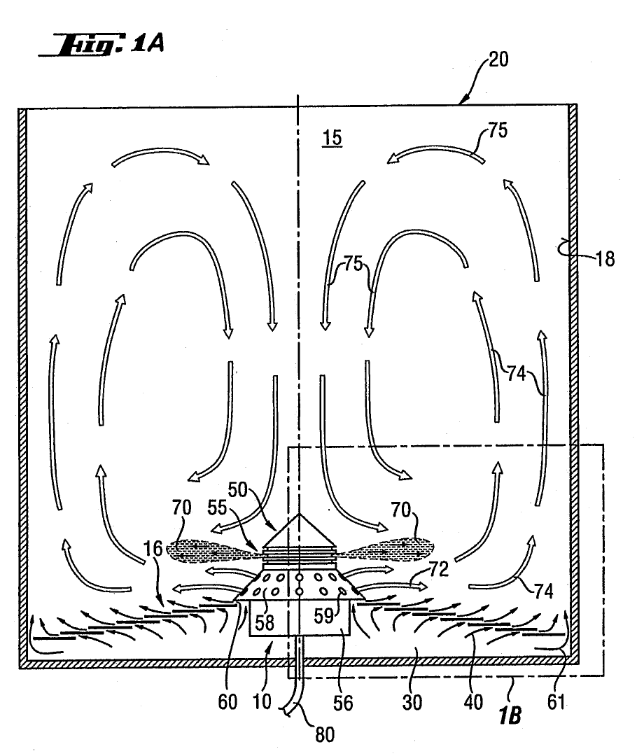

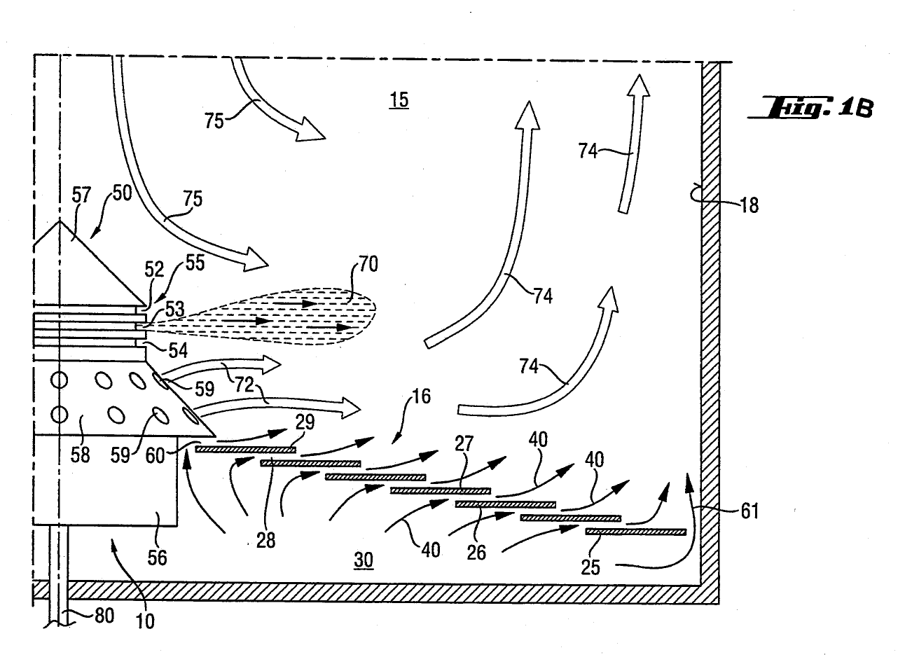

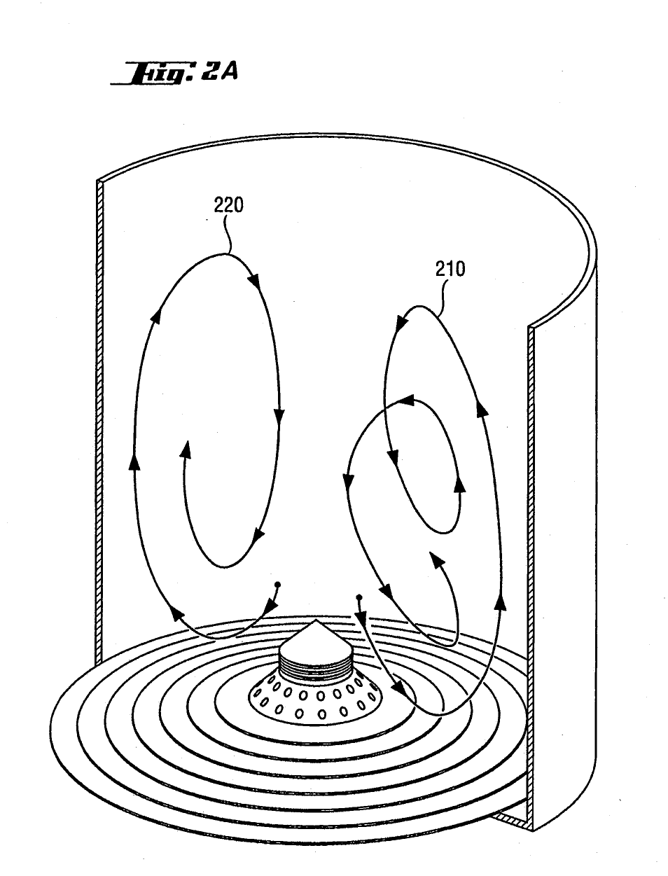

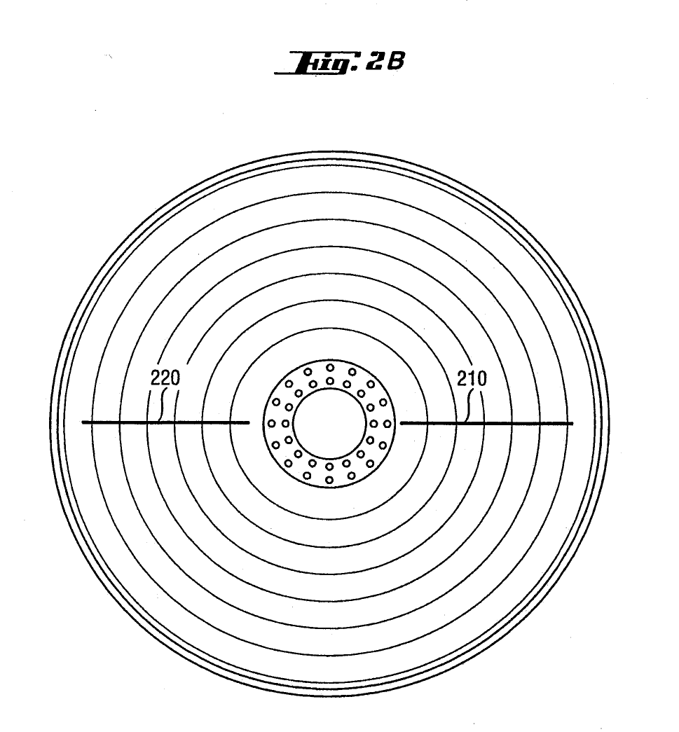

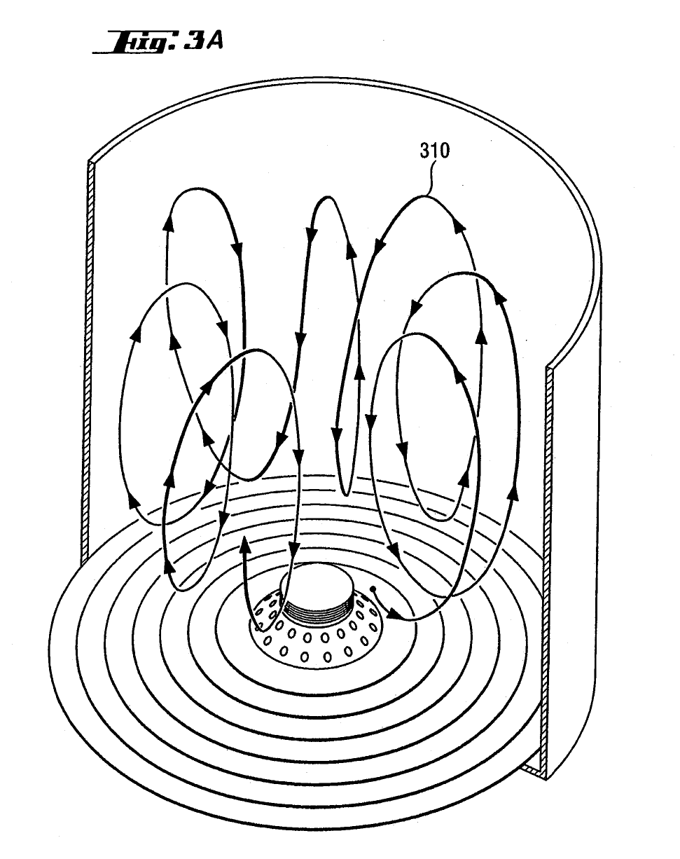

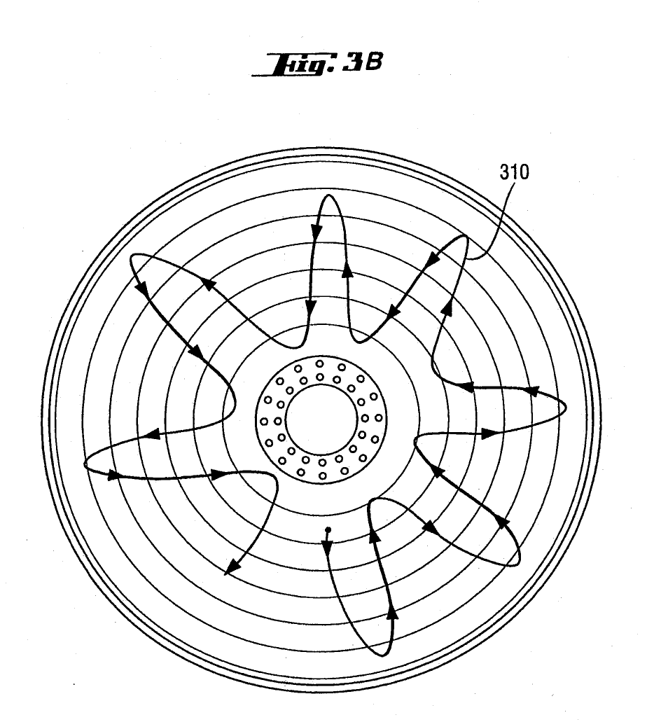

The following description of a preferred device for carrying out the method according to aspects of the invention and also the description of movement paths of catalyst support shaped bodies serve, in connection with the drawing, to explain the invention. There are shown in:
FIG. 1A a vertical sectional view of a preferred device for carrying out the method according to aspects of the invention;
FIG. 1B an enlargement of the framed area in FIG. 1A numbered 1B;
FIG. 2A a perspective sectional view of the preferred device, in which the movement paths of two elliptically circulating catalyst support shaped bodies are represented schematically;
FIG. 2B a plan view of the preferred device and the movement paths according to FIG. 2A;
FIG. 3A a perspective sectional view of the preferred device, in which the movement path of a toroidally circulating catalyst support shaped body is represented schematically;
FIG. 3B a plan view of the preferred device and the movement path according to FIG. 3A.

A device, numbered 10 as a whole, for carrying out the method according to aspects of the invention is shown in FIG. 1A.

The device 10 has a container 20 with an upright cylindrical side wall 18 which encircles a process chamber 15.

The process chamber 15 has a bottom 16 below which is a blowing chamber 30.

The bottom 16 consists of a total of seven annular plates, laid one over another, as guide plates. The seven annular plates are positioned one over another in such a way that an outermost annular plate 25 forms an undermost annular plate on which the other six inner annular plates, each one partially overlapping the one beneath it, are placed.

For the sake of clarity, only some of the total of seven annular plates have reference numbers, for example the two overlapping annular plates 26 and 27. Due to this overlapping and spacing, an annular slot 28 is formed in each case between two annular plates, through which a nitrogen/hydrogen mixture 40 can pass as process gas, with a predominantly horizontally aligned movement component, through the bottom 16.

An annular gap nozzle 50 is inserted from below in the central opening of the central uppermost inner annular plate 29. The annular gap nozzle 50 has a mouth 55 which has a total of three orifice gaps 52, 53 and 54. All three orifice gaps 52, 53 and 54 are aligned so as to spray approximately parallel to the bottom 16, thus horizontally, covering an angle of 360°. Spray gas is expressed via the upper gap 52 and the lower gap 54, the solution to be sprayed is expressed through the central gap 53.

The annular gap nozzle 50 has a rod-shaped body 56 which extends downwards and contains the corresponding channels and feed lines 80. The annular gap nozzle 50 can be formed for example with a so-called rotating annular gap, in which walls of the channel through which the solution is sprayed out rotate relative to each other, in order to avoid blockages of the nozzle, thus making possible a uniform spraying out from the gap 53 over the whole angle of 360°.

The annular gap nozzle 50 has a conical head 57 above the orifice gap 52.

In the area below the orifice gap 54 is a truncated-cone-shaped wall 58 which has numerous apertures 59. As can be seen in particular from FIG. 1B, the underside of the truncated-cone-shaped wall 58 rests on the innermost annular plate 29 in such a way that a slot 60 is formed, through which process air 40 can pass as support gas, between the underside of the truncated-cone-shaped wall 58 and the annular plate 29 lying below and partially overlapping it.

The outer ring 25 is at a distance from the wall 18, with the result that process air 40 can enter the process chamber 15, with a vertical component, in the direction of the arrow given the reference number 61 and thereby gives the process air 40 entering the process chamber 15 through the slot 28 a movement component aligned sharply upwards.

FIG. 1A and sections of FIG. 1B show what relationships form in the device 10 after entry.

A spray cloud 70, the horizontal mirror plane of which runs parallel to the bottom plane, emerges from the orifice gap 53. Support gas passing through the apertures 59 in the truncated-cone-shaped wall 58, which can be for example process air, forms a supporting gas flow 72 on the underside of the spray cloud 70. A radial flow in the direction of the wall 18 by which the process gas 40 is deflected upwards, as represented by the arrow given the reference number 74, is formed by the process gas 40 passing through the numerous slots 28. The shaped bodies are guided upwards by the deflected process gas 40 in the area of the wall 18. The process gas 40 and the catalyst support shaped bodies to be treated then separate from each other, wherein the process gas 40 is discharged through outlets, while the shaped bodies move radially inwards as shown by the arrow 75 and travel vertically downwards in the direction of the conical head 57 of the annular gap nozzle 50. The shaped bodies are deflected there, carried to the upperside of the spray cloud 70 and treated there with the sprayed medium. The sprayed shaped bodies then move again towards the wall 18 and away from each other in the method, as a much larger space is available to the shaped bodies at the annular orifice gap 53 after leaving the spray cloud 70. In the area of the spray cloud 70, the shaped bodies to be treated encounter liquid particles and are moved in the direction of movement towards the wall 18, remaining apart from each other, and treated very uniformly and harmonically with the heated process gas 40 and dried in the method.

Two possible movement paths of two elliptically circulating catalyst support shaped bodies are shown in FIG. 2A by means of the curve shapes given the reference numbers 210 and 220. The elliptical movement path 210 displays relatively large variations in the size of the major and minor axes compared with an ideal elliptical path. The elliptical movement path 220, on the other hand, displays relatively little variation in the size of the major and minor axes and describes close to an ideal elliptical path without a circumferential (horizontal) movement component, as can be seen from FIG. 2B.

A possible movement path of a toroidally circulating catalyst support is shown in FIG. 3A by means of the curve shape given the reference number 310. The toroidally running movement path 310 describes a section of the surface from a virtually uniform torus, the vertical cross-section of which is elliptical and the horizontal cross-section of which is annular. FIG. 3B shows the movement path 310 in plan view.

1. A method for producing a shell catalyst which comprises a porous catalyst support shaped body with an outer shell in which at least one transition metal in metal form is contained, wherein the method is carried out using a device which is set up to cause a circulation of the catalyst support shaped bodies, by means of a process gas with a reductive effect, comprising the steps of
a) charging the device with catalyst support shaped bodies and causing a circulation of the catalyst support shaped bodies by means of a process gas with a reductive effect;
b) impregnating an outer shell of the catalyst support shaped bodies with a transition-metal precursor compound by spraying the circulating catalyst support shaped bodies with a solution containing the transition-metal precursor compound;
c) converting the metal component of the transition-metal precursor compound into the metal form by reduction by means of the process gas; and
d) drying the catalyst support shaped bodies sprayed with the solution.

2. The method according to claim 1, wherein the process gas is a gas mixture comprising an inert gas and also a component with a reductive effect.

3. The method according to claim 2, wherein the inert gas is selected from the group consisting of nitrogen, carbon dioxide and the noble gases, or a mixture of two or more of the above-named gases.

4. The method according to claim 2, wherein the component with a reductive effect is selected from the group consisting of ethylene, hydrogen, CO, NH₃, formaldehyde, methanol and hydrocarbons, or is a mixture of two or more of the above-named compounds.

5. A method for producing a shell catalyst, which comprises a porous catalyst support shaped body with an outer shell in which at least one transition metal in metal form is contained, wherein the method is carried out using a device which is set up to cause a circulation of the catalyst support shaped bodies, comprising the steps of
a) charging the device with catalyst support shaped bodies and causing a circulation of the catalyst support shaped bodies;
b) impregnating an outer shell of the catalyst support shaped bodies with a transition-metal precursor compound by spraying the circulating catalyst support shaped bodies with a solution containing the transition-metal precursor compound;
c) converting the metal component of the transition-metal precursor compound into the metal form by means of a reducing agent which is deposited onto the catalyst support shaped body by impregnating at least the outer shell of the catalyst support shaped body by spraying the circulating catalyst support shaped bodies with a solution containing the reducing agent; and
d) drying the catalyst support shaped bodies.

6. The method according to claim 5, wherein the reducing agent is selected from the group consisting of hydrazine, K-formate, Na-formate, ammonium formate, formic acid, K-hypophosphite, hypophosphoric acid, H₂O₂ and Na-hypophosphite.

7. The method according to claim 5, wherein the process gas is selected from the group consisting of air, oxygen, nitrogen and the noble gases.

8. The method according to claim 1, wherein a fluid bed or a fluidized bed of catalyst support shaped bodies in which the shaped bodies are circulated is produced by means of the process gas.

9. The method according to claim 8, wherein a fluid bed of catalyst support shaped bodies in which the shaped bodies circulate elliptically or toroidally is produced by means of the process gas.

10. The method according to claim 1, wherein the device comprises a process chamber with a bottom and a side wall, wherein the process gas is fed, with horizontal movement component aligned radially outwards, into the process chamber through the bottom of the process chamber in order to produce the catalyst support shaped body fluid bed.

11. The method according to claim 10, wherein the process gas fed into the process chamber is subjected to a circumferential flow component.

12. The method according to claim 11, wherein the process gas fed into the process chamber is subjected to the circumferential flow component by means of guide elements which are arranged between the annular guide plates.

13. The method according to claim 11, wherein the process gas fed into the process chamber is subjected to the circumferential flow component by feeding additional process gas, with a movement component aligned diagonally upwards, through the bottom of the process chamber into the process chamber.

14. The method according to claim 10, wherein the spraying of the catalyst support shaped bodies is carried out by means of an annular gap nozzle which atomizes a spray cloud which runs parallel to the plane of the bottom.

15. The method according to claim 14, wherein the annular gap nozzle is centrally arranged on the bottom and the mouth of the annular gap nozzle is embedded into the circulating catalyst support shaped bodies.

16. The method according to claim 14, wherein a gas support cushion is produced on the underside of the spray cloud.

17. The method according to claim 1, wherein the catalyst support shaped body is formed based on a silicon oxide, an aluminium oxide, a zirconium oxide, a titanium oxide, a niobium oxide or a natural sheet silicate.

18. The method according to claim 1, wherein the catalyst support shaped body has a surface area of less than/equal to 160 m²/g.

19. The method according to claim 1, wherein the catalyst support has a surface area of 160 to 40 m²/g.

20. The method according to claim 1, wherein the catalyst support has a hardness greater than/equal to 20 N.

21. The method according to claim 1, wherein the process gas is heated,.

22. The method according to claim 1, wherein the gas is enriched, before being fed into the process chamber, with the solvent of the solution.

23. The method according to claim 1, wherein the solution of the transition-metal precursor compound contains a noble-metal compound as transition-metal precursor compound.

24. The method according to claim 23, wherein the solution of the transition-metal precursor compound contains a Pd compound as transition-metal precursor compound.

25. The method according to claim 23, wherein the solution of the transition-metal precursor compound contains an Au compound as transition-metal precursor compound.

26. The method according to claim 23, wherein the solution of the transition-metal precursor compound contains an Ag compound as transition-metal precursor compound.

27. The method according to claim 23, wherein the solution of the transition-metal precursor compound contains a Pt compound as transition-metal precursor compound.

28. The method according to claim 1, wherein the solution of the transition-metal precursor compound contains an Ni, Co and/or Cu compound as transition-metal precursor compound.

29. A shell catalyst, comprising a porous catalyst support shaped body with an outer shell, in which at least one transition metal is contained in particulate metallic form, wherein the proportion by mass of transition metal in the catalyst is more than 0.3 mass-%, and the average dispersion of the transition-metal particles is greater than 20%.

30. The catalyst according to claim 29, wherein the concentration of the transition metal varies, over an area of 90% of the shell thickness, the area being at a distance of 5% of the shell thickness from each of the outer and inner shell limit, from the average concentration of transition metal of this area by a maximum of +/−20%.

31. The catalyst according to claim 29, wherein, seen across the thickness of the shell of the catalyst, the maximum concentration of transition metal is in the area of the outer shell limit and the concentration decreases towards the inner shell limit.

32. The catalyst according to claim 31, wherein the concentration of transition metal decreases constantly towards the inner shell limit over an area of at least 25% of the shell thickness.

33. The catalyst according to claim 32, wherein the concentration of transition metal decreases constantly towards the inner shell limit to a concentration of 50 to 90% of the maximum concentration.

34. The catalyst according to claim 29, wherein the transition metal is a noble metal.

35. The catalyst according to claim 34, wherein the catalyst contains one, two or more different noble metals in the shell.

36. The catalyst according to claim 34, wherein the catalyst contains Pd and Au as noble metal and the proportion of Pd in the catalyst is 0.6 to 2.5 mass-%, relative to the mass of the catalyst support loaded with noble metal.

37. The catalyst according to claim 36, wherein the Au/Pd atomic ratio of the catalyst lies between 0 and 1.2.

38. The catalyst according to claim 36, wherein the catalyst comprises an alkali metal acetate.

39. The catalyst according to claim 38, wherein the alkali metal acetate content of the catalyst is 0.1 to 0.7 mol/l.

40. The catalyst according to claim 38, wherein the alkali metal/Pd atomic ratio is between 1 and 12.

41. The catalyst according to claim 36, wherein the catalyst support has a surface area of less than/equal to 160 m²/g.

42. The catalyst according to claim 36, wherein the catalyst support has a surface area of 160 to 40 m²/g.

43. The catalyst according to claim 36, wherein the catalyst support has a bulk density of more than 0.3 g/ml.

44. The catalyst according to claim 36, wherein the catalyst support has an average pore diameter of 8 to 50 nm.

45. The catalyst according to claim 36, wherein the catalyst support has an acidity of between 1 and 150 μval/g.

46. The catalyst according to claim 36, wherein the catalyst support is formed as a sphere with a diameter greater than 1.5 mm.

47. The catalyst according to claim 36, wherein the catalyst support is doped with at least one oxide of a metal selected from the group consisting of Zr, Hf, Ti, Nb, Ta, W, Mg, Re, Y and Fe.

48. The catalyst according to claim 47, wherein the proportion of dopant oxide in the catalyst support is between 0 and 20 mass %.

49. The catalyst according to claim 34, wherein the catalyst contains Pd and Ag as noble metals and the proportion of Pd in the catalyst is 0.01 to 1.0 mass-%. relative to the mass of the catalyst support loaded with noble metal.

50. The catalyst according to claim 49, wherein the Ag/Pd atomic ratio of the catalyst is between 0 to 10.

51. The catalyst according to claim 49, wherein the catalyst support is formed as a sphere with a diameter greater than 1.5 mm.

52. The catalyst according to claim 49, wherein the catalyst support has a surface area of 1 to 50 m²/g.

53. The catalyst according to claim 49, wherein the catalyst support has a surface area of less than/equal to 10 m²/g.

54. The catalyst according to claim 34, wherein the catalyst contains Pd and Pt as noble metal and the proportion of Pd in the catalyst is 0.5 to 5 mass %. relative to the mass of the catalyst support loaded with noble metal.

55. The catalyst according to claim 54, wherein the Pd/Pt atomic ratio of the catalyst is between 10 and 1.

56. The catalyst according to claim 54, wherein the catalyst support is formed as a cylinder or as a sphere with a diameter of 2 to 7 mm.

57. The catalyst according to claim 54, wherein the catalyst support has a surface area of 50 to 400 m²/g.

58. The catalyst according to claim 29, wherein the catalyst contains Co, Ni and/or Cu as transition metal.

59. The catalyst according to claim 29, wherein the catalyst support shaped body is formed based on a silicon oxide, an aluminium oxide, a zirconium oxide, a titanium oxide, a niobium oxide or a natural sheet silicate.

60. The catalyst according to claim 29, wherein the catalyst support has a hardness greater than/equal to 20 N.

61. The catalyst according to claim 29, wherein the proportion of natural sheet silicate in the catalyst support is greater than/equal to 50 mass % relative to the mass of the catalyst support.

62. The catalyst according to claim 29, wherein the catalyst support has an integral pore volume according to BJH greater than 0.30 ml/g.

63. The catalyst according to claim 29, wherein the catalyst support has an integral pore volume according to BJH of between 0.25 and 0.7 ml/g.

64. The catalyst according to claim 29, wherein at least 80%, of the integral pore volume of the catalyst support is formed from mesopores and macropores.

65. The catalyst according to claim 29, wherein the shell of the catalyst has a thickness of less than 300 μm.

66. The catalyst according to claim 25, wherein the shell of the catalyst has a thickness of between 200 and 2000 μm.

67. The device for carrying out the method according to claim 1, in which the catalyst support shaped bodies circulate elliptically or toroidally.

68. The device according to claim 67, wherein the device comprises a process chamber with a bottom and a side wall, wherein the bottom is constructed from several overlapping annular guide plates laid one over another between which annular slots are formed, via which process gas can be fed in with a horizontal movement component aligned radially outwards.

69. The device according to claim 68, wherein an annular gap nozzle is centrally arranged in the bottom, the mouth of which is constructed such that with the nozzle a spray cloud can be sprayed which runs parallel to the bottom plane.

70. The device according to claim 69, wherein outlets for support gas are provided between the mouth of the annular gap nozzle and the bottom lying beneath it in order to produce a support cushion on the underside of the spray cloud.

71. The device according to claim 70, wherein the support gas can be provided by the annular gap nozzle itself and/or by the process gas.

72. The device according to claim 69, wherein the annular gap nozzle has a conical head, and in that the mouth runs along a circular circumferential line of a conical section.

73. The device according to claim 69, wherein there is arranged in the area between the mouth and the bottom lying beneath it a truncated-cone-shaped wall.

74. The device according to claim 73, wherein there is formed between the underside of the truncated-cone-shaped wall and the bottom lying beneath it an annular slot for the passage of process gas.

75. The device according to claim 69, wherein the position of the mouth of the nozzle is height-adjustable.

76. The device according to claim 68, wherein there are arranged between the annular guide plates guide elements which impose an extensive flow component on the process gas passing through.
